(19) United States
(12) Patent Application Publication
(10) Pub. No.: US 2018/0270557 A1
(43) Pub. Date: Sep. 20, 2018

(54) WIRELESS HEARING-AID CIRCUMAURAL HEADPHONE

(71) Applicants: RICHARD CHI-HSUEH, SAN DIEGO, CA (US); CHUNG-YEH HSU, NEW TAIPEI CITY (TW)

(72) Inventors: RICHARD CHI-HSUEH, SAN DIEGO, CA (US); CHUNG-YEH HSU, NEW TAIPEI CITY (TW)

(21) Appl. No.: 15/815,957

(22) Filed: Nov. 17, 2017

Related U.S. Application Data
(60) Provisional application No. 62/472,580, filed on Mar. 17, 2017.

(51) Int. Cl. H04R 1/10; H04R 25/00

(52) U.S. Cl. CPC H04R 1/1008; H04R 25/60; H04R 5/033; H04R 2420/07; H04R 1/1091

(57) ABSTRACT

A wireless hearing-aid circumaural headphone is revealed. The wireless hearing-aid circumaural headphone includes a wireless headphone disposed with a wireless audio receiver, and a wireless audio transmitter electrically connected to the wireless audio receiver. The wireless audio receiver consists of an audio output module, a receiving antenna and a microphone receiver module. The wireless audio transmitter is composed of an audio input module, a microphone input module and a transmitting antenna.

### CROSS REFERENCE TO RELATED APPLICATION

This application claims the benefits from U.S. Provisional Application No. 62/472,580, filed on Mar. 17, 2017, the subject matter of which is incorporated herein by reference.

### BACKGROUND OF THE INVENTION

### Field of the Invention

The present invention relates to a wireless headphone, especially to a wireless hearing-aid circumaural headphone that not only receives audio signals from external electronic devices in a wireless way with the effective range up to 100 meters, but also allows sounds from outside to be audible for hearing aid.

### Description of Related Art

Generally, headphones are speakers designed to hold close to users' ears. The speaker converts electrical signals into sound waves audible to the human ear. Previously, headphones were only used by telephone and radio operators or individuals in the similar industries. With fast development and growing prevalence of portable electronics, the headphones are gradually applied to cellular phones, computers, digital audio players, stereos, home consoles, etc. In order to receive audio signals from the electronics, the headphones are connected to the electronics by audio cables with Tip Ring Sleeve (TRS) plugs. However, the audio cables are easily damaged while being pulled or bent in use or for storage. This results in poor contact. Thereby users have trouble in use because they can't hear the audio signals clearly by the headphones.

In order to solve the problems caused by wired connection, the Bluetooth technology is applied to the headphones and no cable is required by the Bluetooth headphones. Both the headphones and external electronic devices need to be equipped with Bluetooth modules while in use. The electronic devices and the Bluetooth headphones are paired first. Then both parties are able to deliver signals and exchange data. Electrical signals from the electronic devices are transmitted to the Bluetooth headphones wirelessly while the Bluetooth headphones convert the electrical signals to audible sounds waves for users. The wireless transmission is convenient in use. The Bluetooth technology can also be applied to mobile phones for answering incoming phones by one-click. The hand-free feature of the Bluetooth headphones further reduces driver distraction.

There are various kinds of Bluetooth headphones available on the market now. Please refer to TW Pat. No. I533719B “wireless headphone and method for controlling sound played therefrom”, a kind of Bluetooth headphones used for answering phone calls or playing music is revealed. The Bluetooth headphones include no power supply circuit so that they need charging or batteries. In order to save power, the Bluetooth headphones stop working according to detection results of ambient light sources or checking results of blocking signal from the user's ear. Refer to TW Pat. No. I543637 B “headphone wireless expansion device capable of switching among multiple targets and voice control method thereof”, a headphone expansion device is paired with a plurality of information devices for data storage. The headphone expansion device performs pairing by using Bluetooth module. The headphone expansion device can be switched between at least two information devices directly for output of audio signals from the information device and re-pairing is not required when the headphone and the information device are re-connected.

Most of the headphones available now can only receive audio signals from other devices, without picking up sounds from outside. The users need to remove the headphones once they want to talk to others and hear the conversation clearly.

Thus there is room for improvement and there is a need to provide a novel wireless headphone.

### SUMMARY OF THE INVENTION

Therefore it is a primary object of the present invention to provide a wireless hearing-aid circumaural headphone that not only receives audio signals from external electronic devices in a wireless way, but also allows sounds from outside to be audible. Thus the wireless headphone can also be used as a hearing aid.

In order to achieve the above object, a wireless hearing-aid circumaural headphone according to the present invention includes a wireless headphone disposed with a wireless audio receiver, and a wireless audio transmitter electrically connected to the wireless audio receiver. The wireless audio receiver is composed of an audio output module, a receiving antenna and a microphone receiver module. The wireless audio transmitter consists of an audio input module, a microphone input module and a transmitting antenna.

The wireless headphone includes two speakers each of which is covered with soundproofing foam that encompasses user's ear.

Both the wireless audio receiver and the wireless audio transmitter further include a power supply module.

The microphone receiver module and the microphone input module are selected from one of the followings: a dynamic microphone, a condenser microphone, an electret condenser microphone and a MEMS microphone.

The wireless audio receiver of the wireless headphone is further arranged with a volume up/down button, an on button, and a wireless pairing button.

Both the wireless audio receiver and the wireless audio transmitter support Bluetooth.

The wireless audio transmitter is built in an electronic device.

The electronic device can be audio equipment, a smartphone or a tablet computer.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective view of an embodiment according to the present invention;

FIG. 2 is a schematic circuit diagram of a wireless audio receiver of an embodiment according to the present invention;

FIG. 3 is a schematic circuit diagram of a wireless audio transmitter of an embodiment according to the present invention.

### DETAILED DESCRIPTION OF THE PREFERRED EMBODIMENT

In order to learn technical features and functions of the present invention, please refer to the following embodiment with detailed descriptions, the related figures and the reference numbers.

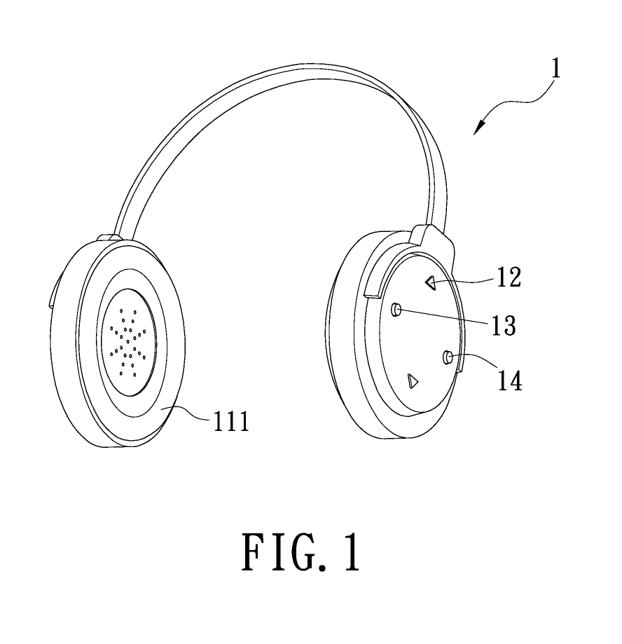

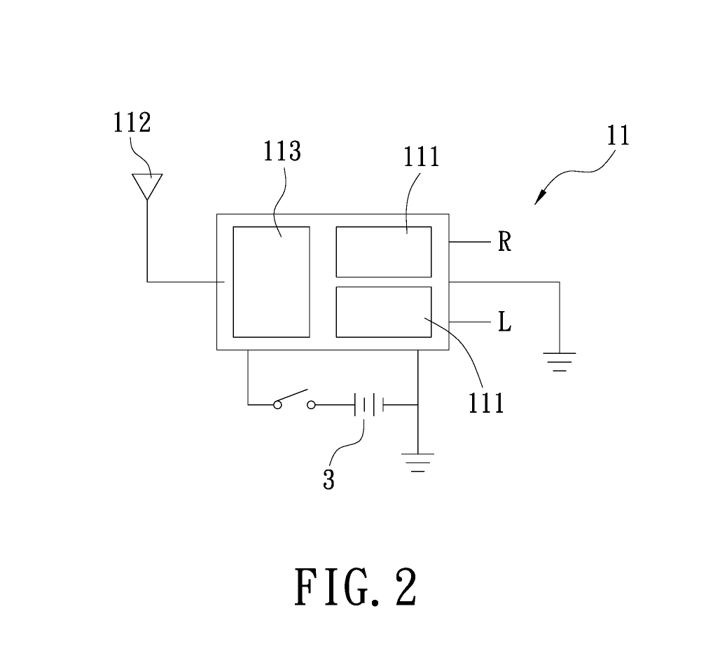

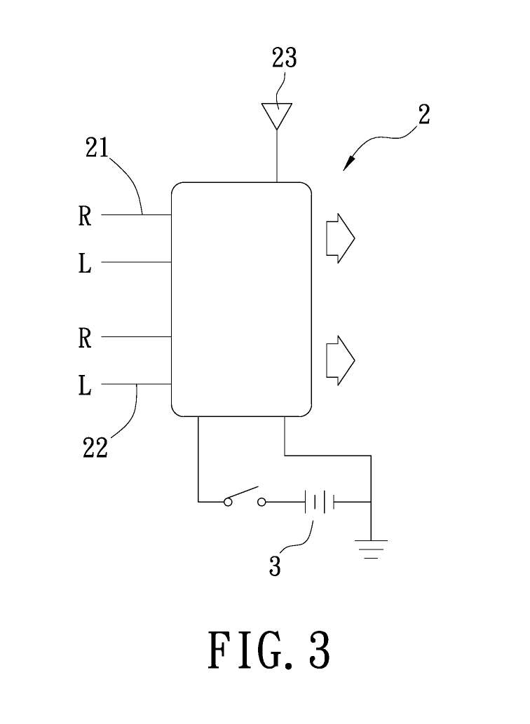

Refer to FIG. 1, FIG. 2 and FIG. 3, a wireless hearing-aid circumaural headphone of the present invention includes a wireless headphone 1 and a wireless audio transmitter 2. The wireless headphone 1 is disposed with a wireless audio receiver 11 while the wireless audio receiver 11 consists of an audio output module 111, a receiving antenna 112 and a microphone receiver module 113. The wireless audio receiver 11 is further set with a volume up/down button 12 for volume adjustment of the wireless headphone 1, an on button 13, and a wireless pairing button 14 used for being paired with other devices. The wireless headphone 1 is a circumaural headphone including two speakers each of which is covered with soundproofing foam enclosing user's ear completely. The wireless audio transmitter 2 is electrically connected to the wireless audio receiver 11 and is composed of an audio input module 21, a microphone input module 22 and a transmitting antenna 23. The wireless audio transmitter 2 is built in electronics such as audio equipment, smartphones or tablet computers, etc. The microphone receiver module 113 and the microphone input module 22 can be selected from one of the followings: dynamic microphone, condenser microphone, electret condenser microphone and MEMS microphone. Both the wireless audio receiver 11 and the wireless audio transmitter 2 further include a power supply module 3 used as a power source. The power supply module 3 can be a dry cell, a lithium battery, or a solar cell. The wireless technology used/supported by the wireless audio receiver 11 and the wireless audio transmitter 2 can be Bluetooth.

Moreover, please refer to the following embodiments so as to learn applications of the present invention.

Refer to FIG. 1, FIG. 2 and FIG. 3, the wireless headphone 1 of the present invention includes the two speakers each of which is covered with a layer of soundproofing foam encompassing user's ear for blocking sounds from outside. The combination of the speaker and the soundproofing foam is called “earcup”. The soft soundproofing foam provides a higher comfort level while the users wear the wireless headphone 1. Moreover, the two earcups are connected by a curved fixing headband. The user fits the fixing headband on top of his/her head and then adjusts a distance between the earcup and the fixing headband so that the earcups are just fit over the user's ears. The fixing headband is also covered by foam so as to release the pressure from the headband acted on the user's head.

The wireless audio receiver 11 of the wireless headphone 1 is mounted in one of the earcups. The audio output module 111 of the wireless audio receiver 11 is connected to the speakers so that sounds are played through the left and the right earcups of the wireless headphone 1. While in use, the on button 13 of the wireless headphone 1 is firstly pressed so that the power supply module 3 starts up and the wireless headphone 1 is powered on. The batteries should be replaced or recharged from a USB port of the wireless headphone 1 once the power supplied is low. The user can press the wireless pairing button 14 to activate the wireless audio receiver 11 when the wireless headphone 1 starts working. Then the electronic device equipped with the wireless audio transmitter 2 searches and finds out the activated wireless audio receiver 11 nearby automatically. The wireless audio transmitter 2 of the electronic device also needs to be turned on. Next the electronic device is paired with the wireless headphone 1 found out and selected. For pairing with the headphone, the effective range available now is up to about 100m.

The users can play audio files by an audio input module of the electronic device. The audio file is sent to the wireless headphone 1 paired with the electronic device through the transmitting antenna 23. The audio file played is received by the receiving antenna 112 of the wireless audio receiver 11 of the wireless headphone 1 and then is played out by the audio output module 111 of the wireless headphone 1. Thus the user can get access to the content of the audio file. Once the electronic device is a smartphone capable of communicating with other electronic devices, other people can talk to the microphone input module 22 of other electronic devices and the user with the wireless headphone 1 can talk to the others through the microphone receiver module 113. Furthermore, the microphone receiver module 113 of the wireless headphone 1 can pick up sounds from outside. Thus the wireless headphone 1 can catch sounds outside the earcups by the microphone receiver module 113 and the user with the wireless headphone 1 can listen to the sounds while the audio file is played by the audio output module 111, even the earcup being arranged with the soundproofing foam. The user can also use the volume up/down button 12 for control of the volume of the sounds caught by the microphone receiver module 113. The wireless headphone 1 can be used as a hearing aid once the volume of the incoming sounds is amplified. Thereby the user with the wireless headphone 1 can listen to the sounds from outside directly without removing the wireless headphone 1 from the head when he needs to communicate with others face-to-face or allow the sounds from outside to be audible.

In summary, the present invention has the following advantages compared with prior arts available now:

1. The wireless hearing-aid circumaural headphone of the present invention including a wireless audio receiver is able to be paired with an electronic device having a wireless audio transmitted (to be connected to the electronic device in a wireless way through Bluetooth). Thus the audio singles played by the electronic device can be sent to the wireless earphone in a wireless way with the effective range of 100 m. Thus the inconvenience caused by wired connection while in use can be avoided. The effective range is more than enough for the users.

2. The wireless audio receiver of the present wireless hearing-aid circumaural headphone includes a microphone receiver module capable of picking up sounds outside the wireless headphone, and an audio output module for playing out the sounds received. Thereby the user with the wireless headphone can hear the sounds from outside, without removing the wireless headphone from the head. The present headphone can also be used as a hearing aid and the volume of the incoming sounds can be adjusted according to users' needs.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A wireless hearing-aid circumaural headphone comprising:
a wireless headphone disposed with
a wireless audio receiver having an audio output module, a receiving antenna and a microphone receiver module; and
a wireless audio transmitter electrically connected to the wireless audio receiver and including an audio input module, a microphone input module and a transmitting antenna.

2. The device as claimed in claim 1, wherein the wireless headphone includes two speakers each of which is covered with soundproofing foam enclosing user's ear.

3. The device as claimed in claim 1, wherein both the wireless audio receiver and the wireless audio transmitter further includes a power supply module.

4. The device as claimed in claim 1, wherein the microphone receiver module and the microphone input module are selected from the group consisting of a dynamic microphone, a condenser microphone, an electret condenser microphone and a MEMS microphone.

5. The device as claimed in claim 1, wherein the wireless audio receiver of the wireless headphone is further disposed with a volume up/down button, an on button, and a wireless pairing button.

6. The device as claimed in claim 1, wherein both the wireless audio receiver and the wireless audio transmitter support Bluetooth.

7. The device as claimed in claim 1, wherein the wireless audio transmitter is built in an electronic device.

8. The device as claimed in claim 7, wherein the electronic device is selected from the group consisting of audio equipment, a smartphone or a tablet computer.
